(19) United States
(12) Patent Application Publication
(10) Pub. No.: US 2009/0236908 A1
(43) Pub. Date: Sep. 24, 2009

(54) RESERVOIR CAPACITOR AND SEMICONDUCTOR MEMORY DEVICE INCLUDING THE SAME

(76) Inventor: Kun-Woo PARK, Gyeonggi-do (KR)

Correspondence Address: MANNAVA & KANG, P.C., 11240 WAPLES MILL ROAD, Suite 300, FAIRFAX, VA, 22030, US

(21) Appl. No.: 12/346,980

(22) Filed: Dec. 31, 2008

(30) Foreign Application Priority Data
Mar. 21, 2008 (KR) 10-2008-0026342
Nov. 26, 2008 (KR) 10-2008-0117999

(51) Int. Cl. H02J 1/00; H02M 3/06

(52) U.S. Cl. 307/19; 307/109

(57) ABSTRACT

A reservoir capacitor includes a first power supply unit and a second power supply unit, and at least two large-capacity capacitors connected in series between the first and second power supply units.

### CROSS-REFERENCE TO RELATED APPLICATIONS

The present invention claims priority of Korean patent application numbers 10-2008-0026342 and 10-2008-0117999, filed on Mar. 21, 2008, and Nov. 26, 2008, respectively, which are incorporated by reference in their entirety.

### BACKGROUND OF THE INVENTION

The present invention relates to an integrated circuit having a reservoir capacitor, and more particularly, to a memory device.

A memory such as a dynamic random access memory (DRAM) is often operated at a high speed with a low voltage. In the high speed operation, small inductance of a package/board disturbs electric current supply. When a low supply voltage is used to reduce power consumption, noise in the supply voltage changes circuit delay significantly, causing errors in memory devices.

In order to overcome such a problem, it is necessary to reduce noise in supply voltages. That is, it is required to reduce an impedance between an external power source and an on-chip circuit or to reduce impedance by increasing capacitance of a reservoir capacitor around a circuit in a chip. Here, a reservoir capacitor has been used in power supply devices for minimizing a voltage drop caused by power consumption.

Although it is possible to obtain sufficiently small impedance using a reservoir capacitor having a small Equivalent Series Resistance (ESR) for high frequency noise, such a solution requires a reservoir capacitor having a relatively large capacitance for a low frequency noise.

### SUMMARY OF THE INVENTION

Some embodiments of the present invention are directed to providing a reservoir capacitor for stabilizing a low frequency noise without necessarily increasing a chip area.

Some embodiments of the present invention are also directed to providing a reservoir capacitor for preventing increases in leakage current by using a large-capacity capacitor when a high voltage is applied.

Some embodiments of the present invention are also directed to providing a reservoir capacitor for realizing a large capacitance without occupying an additional area.

Some embodiments of the present invention are also directed to providing an integrated circuit having a reservoir capacitor having the above features.

Some embodiments of the present invention are also directed to providing a semiconductor memory device for preventing increase in a leakage current by using a cell capacitor as a reservoir capacitor of a peripheral circuit when a high voltage is applied.

In accordance with an aspect of the present invention, there is provided a reservoir capacitor including a first power supply unit and a second power supply unit, and at least two large-capacity capacitors connected in series between the first and second power supply units.

In accordance with another aspect of the present invention, there is provided a reservoir capacitor including a first power supply unit and a second power supply unit, a first capacitor group having a plurality of large-capacity capacitors connected in parallel, and a second capacitor group having a plurality of large-capacitors connected in parallel, wherein the first and second capacitor groups are connected in series between the first and second power supply units.

The reservoir capacitor may further include a MOS capacitor connected with the at least two large-capacity capacitors in parallel between the first and second power supply units. The large-capacity capacitor may be disposed over the MOS capacitor on a substrate.

The large-capacity capacitor may be a stack capacitor including a lower electrode conductive layer, a dielectric layer, and an upper electrode conductive layer stacked in sequence. The first power supply unit may include a first power line receiving a first power supply, and the first electrode may be connected to the first power line, and the second power supply unit may include a second power line receiving a second power supply, and the third electrode may be connected to the second power line.

The dielectric layer may be a high dielectric thin film or a ferroelectric thin film.

In accordance with further aspect of the present invention, there is provided a semiconductor memory device including a memory cell having a cell capacitor, and a peripheral circuit having a reservoir capacitor. The reservoir capacitor includes at least two large-capacity capacitors connected in series between first and second power supply units, and each of the large-capacity capacitors has a capacitance substantially the same as a capacitance of the cell capacitor.

In accordance with still aspect of the present invention, there is provided a semiconductor memory device including a memory cell having a cell capacitor, and a peripheral circuit having a reservoir capacitor. The reservoir capacitor includes a first capacitor group having a plurality of large-capacity capacitors connected in parallel, and a second capacitor group having a plurality of large capacitors connected in parallel. The first and second capacitor groups are connected in series between first and second power supply units, and each of the large-capacity capacitors of the first and second capacitor groups has capacitance identical to the cell capacitor.

Since a memory device includes a cell array region and a peripheral region in a plane, the large-capacity capacitor is patterned in the peripheral circuit region identically when the cell capacitor is patterned in the cell region. Particularly, the cell capacitor is a stack capacitor having a capacitor on bit line (COB) structure formed over a bit line on a substrate in the memory device according to the embodiments of the present invention.

In forming the cell capacitor having the stack structure, large-capacity capacitors may be formed in the peripheral circuit region identically. That is, the large-capacity capacitors may be formed in the peripheral circuit region without metal contact, and the large-capacity capacitors may be disposed over the MOS capacitor.

The first power supply unit may be one selected from the group consisting of a supply voltage (Vdd) line, a high voltage (Vpp) line, a core voltage (Vcore) line, and a bit line precharge voltage (Vblp) line. The second power supply unit may be a ground voltage (Vss) line or a back bias voltage (Vbb).

### BRIEF DESCRIPTION OF THE DRAWINGS

FIG. 1 is a diagram illustrating a reservoir capacitor in accordance with a first embodiment of the present invention.

FIG. 2 is a circuit diagram of a reservoir capacitor in accordance with a second embodiment of the present invention.

FIG. 3 is a layout view of a reservoir capacitor shown in FIG. 2.

FIG. 4 is a cross-sectional view of the reservoir capacitor in FIG. 3 taken along the line A-B.

FIG. 5 is a cross-sectional view of a substrate having a MOS capacitor and large-capacity capacitors of a reservoir capacitor.

FIG. 6 is a circuit diagram illustrating a DRAM.

FIG. 7 is a cross-sectional view of a memory device in accordance with a third embodiment of the present invention.

### DESCRIPTION OF SPECIFIC EMBODIMENTS

Other objects and advantages of the present invention can be understood by the following description, and become apparent with reference to the embodiments of the present invention.

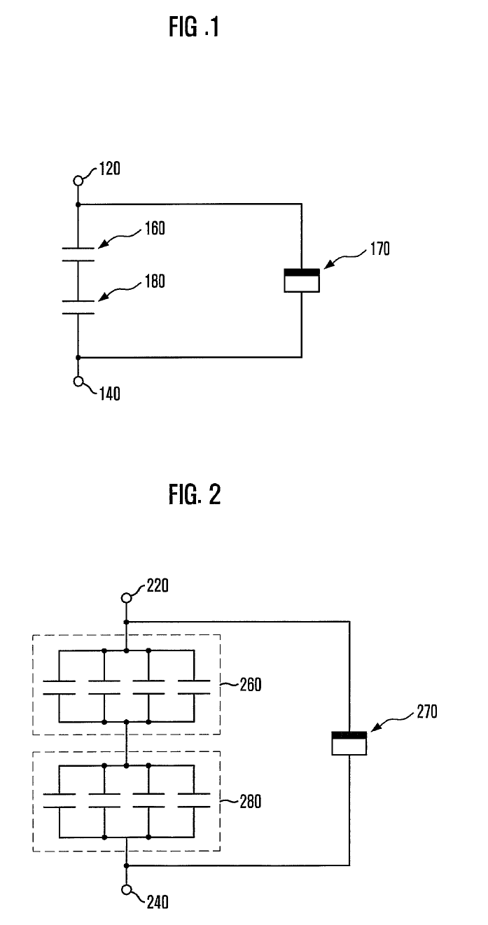

FIG. 1 is a diagram illustrating a reservoir capacitor in accordance with a first embodiment of the present invention.

Referring to FIG. 1, the reservoir capacitor according to the first embodiment includes a first power supply unit 120, a second power supply unit 140, and at least two large-capacity capacitors 160 and 180 between the first and second power supply units 120 and 140. The reservoir capacitor according to the first embodiment further includes a MOS capacitor 170 connected to the large-capacity capacitors in parallel between the first and second power supply units 120 and 140. The MOS capacitor 170 may be omitted. The MOS transistor 170 has a capacitance in a ηF range (for example, several tens of ηF). The large-capacity capacitors 160 and 180 each have a capacitance in a μF range (for example, several μF). The large-capacity capacitors 160 and 180 each have a stacking structure of a first electrode (storage node), a dielectric, and a second electrode (plate). The first and second electrodes of each of the large-capacity capacitors 160 and 180 may be formed using a polysilicon or a metal thin film. The dielectric may be formed using high dielectric or ferroelectrics.

As described above, the reservoir capacitor according to the first embodiment uses the large-capacity capacitors 160 and 180 for removing low frequency noise. Since the large-capacity capacitors 160 and 180 each have a problem that a leakage current increases when a high voltage is applied, at least two large-capacity capacitors may be connected in series.

The large-capacity capacitors 160 and 180 have a large ESR. Since high frequency noise may not be removed by using only the large-capacity capacitors 160 and 180, the MOS capacitor 170 is used in combination with the large-capacity capacitors 160 and 180 to remove any high frequency noise.

FIG. 2 is a circuit diagram of a reservoir capacitor in accordance with a second embodiment of the present invention.

Referring to FIG. 2, the reservoir capacitor includes a first power supply unit 220, a second power supply unit 240, a first capacitor group 260 having a plurality of large-capacity capacitors connected in parallel, and a second capacitor group 280 having a plurality of large-capacity capacitors connected in parallel.

Here, the first and second capacitor groups 260 and 280 are connected between the first and second power supply groups 220 and 240 in series. In addition, the reservoir capacitor in FIG. 2 further includes a MOS capacitor 270 connected in parallel to the first and second power supply units 220 and 240. The MOS capacitor 270 may be optional.

The MOS capacitor 270 has a capacitance in the ηF range (for example, several tens of ηF). Each of the large-capacity capacitors in the first and second capacitor groups 260 and 280 has a capacitance in the μF (for example, several μF). Although the two capacitor groups 260 and 280 are shown to be connected in series in FIG. 2, three or more capacitor groups 260 and 280 may also be connected in series.

Similar to the large capacitors 160 and 180 in FIG. 1, each of the large-capacity capacitors in each capacitor groups 260 and 280 includes a stacking structure of a first electrode (a storage node), a dielectric, and a second electrode (a plate). The first and second electrodes of the large-capacity capacitors of the capacitor groups 260 and 280 may be formed using a polysilicon and a metal thin film, and the high dielectric and the ferroelectrics.

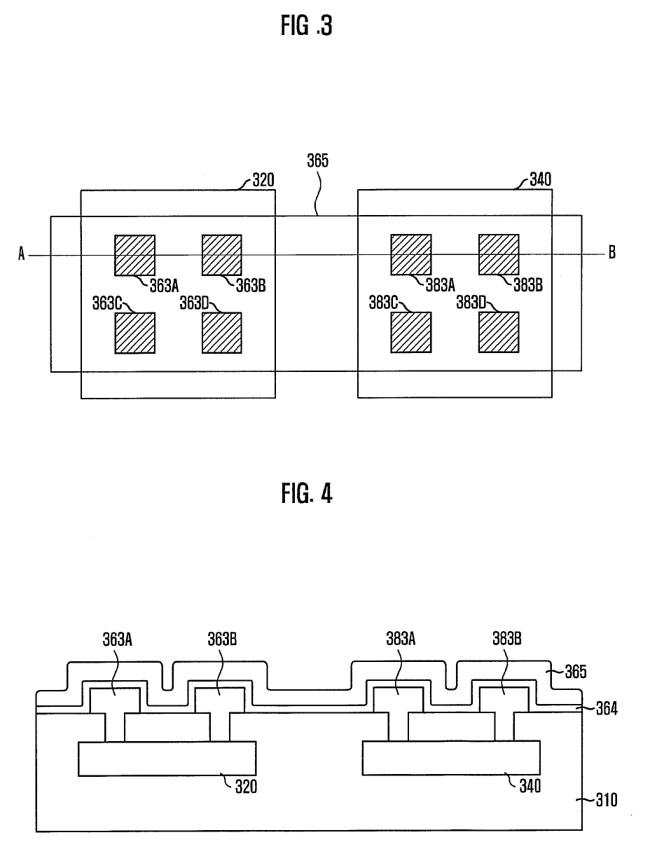

FIG. 3 is a layout view of capacitor groups 260 and 280 in FIG. 2. If the capacitor groups 260 and 280 are connected in series as in the second embodiment, it is easy to pattern second electrodes (plates) of a large-capacity capacitor of the capacitor groups 260 and 280.

Referring to FIG. 3, a first power line 320 for receiving first power supply and a second power line 340 for receiving second power supply are formed. The first power line 320 connects to first electrodes 363A, 363B, 363C, and 363D of large-capacity capacitors in the first capacitor group 260. The second power line 340 connects to first electrodes 383A, 383B, 383C, and 383D of large-capacity capacitors in the second capacitor group 280. The second electrodes (plates) 365 of large-capacity capacitors of the first and second capacitor groups 260 and 280 are commonly formed by single conductive layer pattern.

The reservoir capacitor according to the first embodiment shown in FIG. 1 may have the same layout as the layout of FIG. 3 except that the number of the large-capacity capacitors may change.

FIG. 4 is a cross-sectional view of the reservoir capacitor of FIG. 3 taken along the line A-B.

Referring to FIG. 4, a first power line 320 and a second power line 240 are prepared on a substrate 310. The first and second power lines 320 and 340 are patterned as a conductive layer such as metal or polysilicon. The first electrodes 363A, 363B, 383A, and 383B penetrate an insulation layer and contact with the first and second power lines 320 and 340. A dielectric 364 is formed over the substrate 310 including the first electrodes 363A, 363B, 383A, and 383B. A second electrode 365 is formed over the dielectric 364. The dielectric 364 and the second electrode 365 may each be commonly formed by the same thin film for all of the large-capacity capacitors in the present embodiment. Alternatively, the dielectric 364 and the second electrode 365 may be formed separately for each large-capacity capacitor.

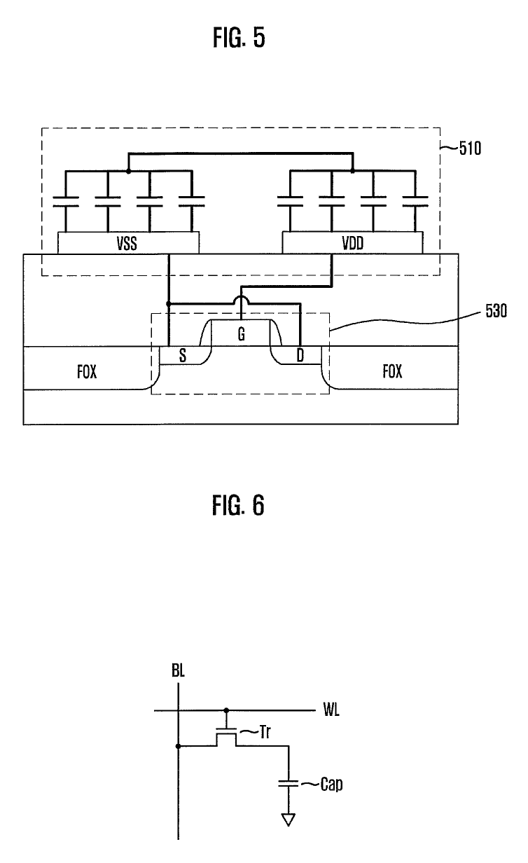

FIG. 5 is a cross-sectional view of a substrate having a MOS capacitor and a large-capacity capacitor of a reservoir capacitor. A large-capacity capacitor 510 is disposed on a top of a MOS capacitor 530 over a substrate (e.g., a silicon substrate Si-sub).

The MOS capacitor 530 includes a gate G, a source S, and a drain D formed at the silicon substrate Si-sub. The source S and the drain D are connected to the second power line VSS, and the gate G is connected to the first power line VDD. In FIG. 5, the large-capacity capacitors and the connection lines are illustrated as an equivalent circuit.

FIG. 6 is a circuit diagram illustrating a DRAM according to the related art. Referring to FIG. 6, the memory cell according to the related art includes an access transistor Tr connected to a word line and a bit line and a cell capacitor Cap for storing cell data. The reservoir capacitor according to the embodiments of the present invention can be applied to the memory device having the cell capacitor shown in FIG. 6.

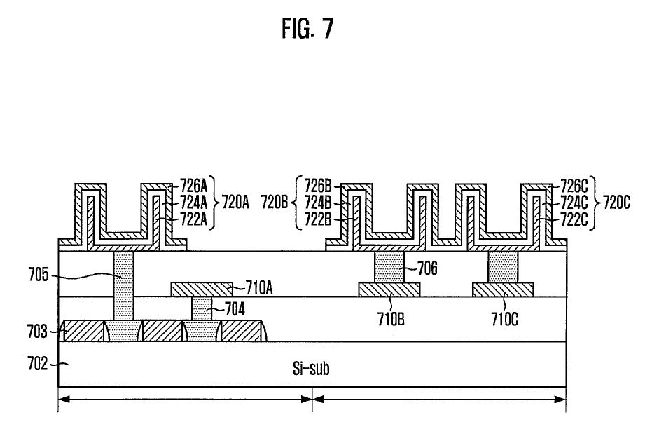

FIG. 7 is a cross-sectional view of a memory device in accordance with a third embodiment of the present invention. FIG. 7 illustrates how a memory cell and a reservoir capacitor are configured in a semiconductor memory device including a memory cell having a cell capacitor and a peripheral circuit having a reservoir capacitor.

Referring to FIG. 7, a memory cell having a cell capacitor 720A is formed in a cell region, and peripheral circuits including a reservoir capacitor are formed in a peripheral region.

The reservoir capacitor includes a first large-capacity capacitor 720B and a second large-capacity capacitor 720C connected in series between a first power line 710B and a second power line 710C. Although two large-capacity capacitors are shown in FIG. 7, more than two large-capacity capacitors may be included. Although it is not shown in FIG. 7, a reservoir capacitor may be formed in various methods as shown in FIGS. 1, 2, and 5. Particularly, a MOS capacitor connected to the first and second large-capacity capacitors 720B and 720C may be further included as shown in FIG. 5.

In the present embodiment, the first and second large-capacity capacitors 720B and 720C of the reservoir capacitor may each have substantially the same capacitance as the capacitance of the cell capacitor 720A.

The cell capacitor 720A is a stack capacitor having a capacitor on bit-line (COB) structure formed over the substrate for or on the bit line 710A. The cell capacitor 720A includes a storage node 722, a dielectric 724A formed over the storage node 722A, and a plate electrode 726A formed over the dielectric 724A.

The first large-capacity capacitor 720B includes a first electrode 722B having the same material and the same surface area as the material and the surface area of the storage node 722A, respectively, a dielectric 724B formed over the first electrode 722A and having the same material as the material of the dielectric 724A of the cell capacitor, and a second electrode 726B formed over the dielectric 724B and made of the same material as the material of the plate electrode 726A. Therefore, the cell capacitor 720A and the first large-capacity capacitor 720B each have substantially the same capacitance. A first electrode 722C, a dielectric 724C, and a second electrode 726C of the second large-capacity capacitor may be substantially identical to those of the first large-capacity capacitor 720B.

The first electrode 722B of the first large-capacity capacitor 720B is connected to and in contact with the first power line 710B, and the first electrode 722C of the second large-capacity capacitor 720C is connected to and in contact with the second power line 710C. The first electrode 722B of the first large-capacity capacitor 720B and the first electrode 722C of the second large-capacity capacitor 720C are formed by patterning conductive layers of same material, respectively.

The second electrode 726B of the first large-capacity capacitor 720B and the second electrode 726C of the second large-capacity capacitor 720C are commonly formed by single conductive pattern.

The first power line 710B and the second power line 710C are formed of conductive layer of a same material as a conductive layer of the bit line in a cell region. The first and second power lines 710B and 710C are separated by patterning. In addition to using the conductive layer for a bit line, other conductive layers may also be used for the first and second power lines 710B and 710C.

The first power line 710B receives a voltage level corresponding to a logical ‘high’ for one or more signals used in internal circuits of a memory. For example, the first power line 710B may be any one of a supply voltage (Vdd) line, a high voltage (Vpp) line, a core voltage (Vcore) line, and a bit line precharge voltage (Vblp) line.

The second power line 710C receives a voltage level corresponding to a logical ‘low’ for one or more signals used in internal circuits of a memory. For example, the second power line 710C may be a ground voltage (Vss) line or a back vias voltage (Vbb) line.

Each dielectric layer of the first and second large-capacity capacitors 720B and 720C may be a high dielectric film or a ferroelectric layer.

In FIG. 7, a reference numeral 702 denotes a silicon substrate Si-sub, a reference numeral 703 denotes a gate electrode of a cell transistor, and reference numerals 704, 705, and 706 are contact plugs.

The semiconductor memory device according to the fourth embodiment of the present invention may include the reservoir capacitor of FIG. 5 in each of the capacitor groups. Here, each of the large-capacity capacitors in each group has the same structure of a cell capacitor.

As described above, the reservoir capacitor and the semiconductor having the same according to the embodiments of the present invention can be applied to all of cases of using a power supply scheme with a reservoir capacitor in a semiconductor integrated circuit such as a dynamic random access memory (DRAM) and other semiconductor devices. The reservoir capacitor according to the embodiments of the present invention is very useful in a DRAM having a cell capacitor formed over a bit line. Particularly, the reservoir capacitor according to the embodiments of the present invention embodiments of the present invention can be advantageously formed in all peripheral circuits that does not have a metal contact because a cell capacitor is not used in a peripheral circuit area. Since a power terminal may be disposed over the MOS transistor and there is no limitation that prevents forming of the reservoir capacitor of the present invention, it is possible to increase capacitance without increasing an area. In addition, a large-capacity capacitor can be formed in any region in a peripheral circuit.

While the present invention has been described with respect to the specific embodiments, it will be apparent to those skilled in the art that various changes and modifications may be made without departing from the spirit and scope of the invention as defined in the following claims.

Embodiments of the present invention relate to an integrated circuit having a reservoir capacitor. The reservoir capacitor of the present embodiment uses a large-capacity capacitor to remove low frequency noise. The large-capacity capacitor has a problem of a leakage that increases when a high voltage is applied. In order to overcome the problem, at least two large-capacity capacitors may be connected in series.

Although a capacitance in the μF range may be used to remove the low frequency noise, the capacitance of the MOS capacitor may be in the ηF range. In order to obtain the capacitance in the μF range without increasing area, a capacitance several hundred times greater than that of the MOS capacitor may be used in each of unit areas. Since the cell capacitor of a memory device is about 300 to 400 times bigger in size than the MOS capacitor, it is possible to have large-capacity capacitors that substantially have the same layout and materials as the cell capacitor as the reservoir capacitor.

Also, the large-capacity capacitor may be a capacitor having a large ESR. Although high frequency noise may not be removed with only large-capacity capacitors, a MOS capacitor may be used in combination with the large-capacitor capacitors to remove the high frequency noise.

The reservoir capacitor according to the embodiment of the present invention may reduce power noise of about 100 mV to 200 mV up to about 50 mV. Also, the reservoir capacitor according to the embodiment of the present invention can stabilize low frequency noise such as sensing noise.

According to an exemplary embodiment of the present invention, capacitance of a reservoir capacitor may be increased without increasing a size of a chip.

The reservoir capacitor formed using a cell capacitor may be used to stabilize power sources such as an internal power source and an external power source used in a semiconductor device such as DRAM. Particularly, the reservoir capacitor according to the present invention may be used to stabilize a supply voltage having a low voltage level. The reservoir capacitor according to the present invention may also be used to make connections for shorting AC or/and opening DC between power sources having a small voltage difference.

What is claimed is:

1. A reservoir capacitor, comprising:
a first power supply unit and a second power supply unit; and
at least two large-capacity capacitors connected in series between the first and second power supply units.

2. The reservoir capacitor of claim 1, further comprising:
a MOS capacitor connected in parallel with the at least two large-capacity capacitors.

3. The reservoir capacitor of claim 2, wherein the large-capacity capacitors are disposed over the MOS capacitor on a substrate.

4. The reservoir capacitor of claim 1, wherein the large-capacity capacitor is a stack capacitor including a lower electrode conductive layer, a dielectric layer, and an upper electrode conductive layer stacked in sequence.

5. The reservoir capacitor of claim 1, wherein the at least two large-capacity capacitors include:
a first large-capacity capacitor having a first electrode connected to the first power supply unit, a first dielectric formed over the first electrode, and a second electrode formed over the first dielectric; and
a second large-capacity capacitor having a third electrode connected to the second power supply unit, a second dielectric formed over the third electrode, and a fourth electrode formed over the second dielectric.

6. The reservoir capacitor of claim 5, wherein the first electrode and the third electrode are separated by patterning a conductive layer of a same material deposited over a substrate.

7. The reservoir capacitor of claim 5, wherein the second electrode and the fourth electrode are commonly formed by a single conductive pattern.

8. The reservoir capacitor of claim 1, wherein the large-capacity capacitor has a capacitance in a μF range.

9. The reservoir capacitor of claim 2, wherein the MOS capacitor has a capacitance in a ηF range.

10. The reservoir capacitor of claim 5, wherein the first power supply unit includes a first power line receiving a first power supply which the first electrode is connected to and the second power supply unit includes a second power line receiving a second power supply, which the third electrode is connected to.

11. The reservoir capacitor of claim 4, wherein the dielectric layer is a high dielectric thin film or a ferroelectric thin film.

12. The reservoir capacitor of claim 2, wherein the MOS capacitor has a gate, a source, and a drain formed over a substrate, the source and the drain are connected to the second power supply unit, and the gate is connected to the first power supply unit.

13. A reservoir capacitor, comprising:
a first power supply unit and a second power supply unit;
a first capacitor group having a plurality of large-capacity capacitors connected in parallel; and
a second capacitor group having a plurality of large-capacitors connected in parallel,
wherein the first and second capacitor groups are connected in series between the first and second power supply units.

14. The reservoir capacitor of claim 13, further comprising:
a MOS capacitor connected in parallel to the first and second capacitor groups.

15. The reservoir capacitor of claim 14, wherein the large-capacity capacitors of each of the first and second capacitor groups is disposed over the MOS capacitor on a substrate.

16. The reservoir capacitor of claim 13, wherein each of the plurality of large-capacity capacitors in the first capacitor group includes a first electrode connected to the first power supply unit, a first dielectric formed over the first electrode, and a second electrode formed over the first dielectric, and
wherein each of the plurality of large-capacity capacitors in the second capacitor group includes a third electrode contacting to the second power supply unit, a second dielectric formed over the third electrode, and a fourth electrode formed over the second dielectric.

17. The reservoir capacitor of claim 16, wherein the first power supply unit includes a first power line receiving a first power supply, which the first electrode is connected to, and the second power supply unit includes a second power line receiving a second power supply, which the third electrode is connected to.

18. The reservoir capacitor of claim 16, wherein the second electrode and the fourth electrode are commonly formed by a single conductive pattern.

19. The reservoir capacitor of claim 16, wherein the first and second dielectric layers are each a high dielectric thin film or a ferroelectric thin film.

20. The reservoir capacitor of claim 13, wherein the large-capacity capacitor has a capacitance in a μF range.

21. The reservoir capacitor of claim 14, wherein the MOS capacitor has a capacitance in a ηF range.

22. The reservoir capacitor of claim 14, wherein the MOS capacitor has a gate, a source, and a drain formed over a substrate, and the source and the drain are connected to the second power supply unit, and the gate is connected to the first power supply unit.

23. A semiconductor memory device comprising:
a memory cell having a cell capacitor; and
a peripheral circuit having a reservoir capacitor, wherein the reservoir capacitor includes:
at least two large-capacity capacitors connected in series between first and second power supply units, and
wherein each of the large-capacity capacitors has a capacitance substantially the same as a capacitance of the cell capacitor.

24. The semiconductor memory device of claim 23, wherein the reservoir capacitor further includes a MOS capacitor connected in parallel to the at least two large-capacity capacitors.

25. The semiconductor memory device of claim 23, wherein the cell capacitor is formed over a bit line on a substrate.

26. The semiconductor memory device of claim 23, wherein the cell capacitor includes a storage node, a first dielectric formed over the storage node, and a plate electrode formed over the first dielectric and wherein each of the two large-capacity capacitors includes a first electrode having same material and same surface area as the storage node, a second dielectric formed over the first electrode and having same material as the first dielectric, and a second electrode formed over the second dielectric and having same material as the plate electrode.

27. The semiconductor memory device of claim 23, wherein each of at least two large-capacity capacitors includes:
a first large-capacity capacitor having a first electrode connected to the first power supply unit, a first dielectric formed over the first electrode, and a second electrode formed over the first electrode; and
a second large-capacity capacitor having a third electrode connected to the second power supply unit, a second dielectric formed over the third electrode, and a fourth electrode formed over the second dielectric.

28. The semiconductor memory device of claim 27, wherein the first electrode and the third electrode are separated by patterning a conductive layer of a same material deposited on a substrate.

29. The semiconductor memory device of claim 27, wherein the second electrode and the fourth electrode are commonly formed by a single conductive layer pattern.

30. The semiconductor memory device of claim 27, wherein the first power supply unit includes a first power line receiving a first power supply, which the first electrode is connected to, and the second power supply unit includes a second power line receiving a second power supply, which the third electrode is connected to.

31. The semiconductor memory device of claim 30, wherein the first power line and the second power line are separated by patterning conductive layers of same material as a conductive layer for a bit line.

32. The semiconductor memory device of claim 31, wherein the first power line is one of a supply voltage line, a high voltage line, a core voltage line, and a bit line precharge voltage.

33. The semiconductor memory device of claim 31, wherein the second power line is a ground voltage line or a back vias voltage line.

34. The semiconductor memory device of claim 26, wherein the first dielectric and the second dielectric are each a high dielectric thin film or a ferroelectric thin film.

35. The semiconductor memory device of claim 23, wherein the large-capacity capacitor has a capacitance in a range of μF.

36. The semiconductor memory device of claim 24, wherein the MOS capacitor has a capacitance in a range of ηF.

37. The semiconductor memory device of claim 24, wherein the MOS capacitor has a gate, a source, and a drain formed over a substrate, the source and the drain are connected to the second power supply unit, and the gate is connected to the first power supply unit.

38. A semiconductor memory device comprising:
a memory cell having a cell capacitor; and
a peripheral circuit having a reservoir capacitor, wherein the reservoir capacitor includes:
a first capacitor group having a plurality of large-capacity capacitors connected in parallel; and
a second capacitor group having a plurality of large capacitors connected in parallel,
wherein the first and second capacitor groups are connected in series between first and second power supply units, and each of the large-capacity capacitors of the first and second capacitor groups has capacitance identical to the cell capacitor.

39. The semiconductor memory device of claim 38, further comprising:
a MOS capacitor connected in parallel to the first and second capacitor groups.

40. The semiconductor memory device of claim 38, wherein the cell capacitor is formed over a bit line on a substrate.

41. The semiconductor memory device of claim 39, wherein the large capacitor is disposed over the MOS capacitor on a substrate.

42. The semiconductor memory device of claim 38, wherein the cell capacitor includes a storage node, a first dielectric formed over the storage node, and a plate electrode formed over the first dielectric and wherein the large-capacity capacitor includes a first electrode having same material and a same surface area as the storage node, a second dielectric formed over the first electrode and having same material as the first dielectric, and a second electrode formed over the second dielectric and having same material as the plate electrode.

43. The semiconductor memory device of claim 38, wherein each of the plurality of large-capacity capacitors in the first capacitor group includes a first electrode connected to the first power supply unit, a first dielectric formed over the first electrode, and a second electrode formed over the first dielectric, and
wherein each of the plurality of large-capacity capacitors in the second capacitor group includes a third electrode connected to the second power supply unit, a second dielectric formed over the third electrode, and a fourth electrode formed over the second dielectric.

44. The semiconductor memory device of claim 43, wherein the first power supply unit includes a first power line receiving a first power supply, which the first electrode is connected to, and the second power supply unit includes a second power line receiving a second power supply, which the third electrode is connected to.

45. The semiconductor memory device of claim 44, wherein the first power line and the second power line are separated by patterning a conductive layer of a same material as a bit line.

46. The semiconductor memory device of claim 43, wherein the second electrode and the fourth electrode are commonly formed by a single conductive pattern.

47. The semiconductor memory device of claim 45, wherein the first power line is one of a supply voltage line, a high voltage line, a core voltage line, and a bit line precharge voltage line.

48. The semiconductor memory device of claim 47, wherein the second power line is a ground voltage line or a back vias voltage line.

49. The semiconductor memory device of claim 43, wherein the first dielectric and the second dielectric are each a layer of a high dielectric thin film or a ferroelectric thin film.

50. The semiconductor memory device of claim 38, wherein the large-capacity capacitor has a capacitance in a μF range.

51. The semiconductor memory device of claim 39, wherein the MOS capacitor has a capacitance in a ηF range.

52. The semiconductor memory device of claim 39, wherein the MOS capacitor has a gate, a source, and a drain formed over a substrate, the source and the drain are connected to the second power supply unit, and the gate is connected to the first power supply unit.
